(19) United States
(12) Patent Application Publication
(10) Pub. No.: US 2013/0276350 A1
(43) Pub. Date: Oct. 24, 2013

(54) BREAKAWAY COUPLING FOR FISHING LURE

(71) Applicant: Miles K. Smith, Grand Rapids, MI (US)

(72) Inventor: Miles K. Smith, Grand Rapids, MI (US)

(21) Appl. No.: 13/790,510

(22) Filed: Mar. 8, 2013

Related U.S. Application Data
(60) Provisional application No. 61/637,460, filed on Apr. 24, 2012.

(51) Int. Cl. A01K 85/02

(52) U.S. Cl. CPC A01K 85/02
USPC 43/42.38; 43/43.12

(57) ABSTRACT

A breakaway coupling includes a socket for captively receiving the shank and eyelet of a fish hook. The breakaway coupling includes a coupling element having a pair of tines with barbs for releasably snap-fitting the coupling element into a socket of a holder having a loop for coupling to a lure. The holder includes a slotted body for releasably holding the hook and barbed coupling element with a desired breakaway force. In another embodiment of the invention, the hook can be integrally molded to the coupling element which snap-fits within the socket.

### CROSS-REFERENCE TO RELATED APPLICATION

This application claims priority under 35 U.S.C. §119(e) to, and the benefit of, U.S. Provisional Patent Application No. 61/637,460, entitled “BREAKAWAY COUPLING FOR FISHING LURE,” filed on Apr. 24, 2012, the entire disclosure of which is hereby incorporated by reference.

### BACKGROUND OF THE INVENTION

The present invention relates to a breakaway coupling for allowing a snagged fishing lure to break away from the object capturing the hooks of the lure.

Fishermen frequently lose fishing lures when snagged on underwater objects. Such lures can be relatively expensive or one of the fisherman's favorite effective lures. Several attempts have been made to devise release mechanisms for allowing the hook portion of a lure to break away from the lure itself, thereby saving the lure and the fisherman significant money inasmuch as the hooks can be inexpensively replaced. U.S. Pat. Nos. 4,696,121, D 501,039, 7,735,256, and 6,748,694 are representative of earlier efforts to provide a breakaway coupling between a fishing lure and hooks associated with the lure. Also, a ball and socket breakaway coupling has been proposed.

Such devices, although somewhat effective, can be difficult to manufacture and may not provide the flexibility for different test strength fishing lines. There remains a need for a breakaway coupling for a fishing lure in which the coupling of a hook remains with the lure and only the hook is lost. Alternatively, at least part of the coupling remains intact and coupled to the lure, while a less expensive replaceable element containing the hook is separated from the freed lure.

### SUMMARY OF THE INVENTION

In one embodiment of the present invention, a breakaway coupling is provided for use with a fishing lure. The coupling includes a holder with a loop at one end and a socket at an opposite end, the socket including an axially extending aperture terminating in a transversely extending slot through said holder. The coupling also includes a coupling element having at least one resilient tine for releasably coupling the coupling element to said socket. The coupling element is adapted to receive a fish hook, with said coupling element being designed to release from the holder to allow the recovery of a lure in the event of a snag.

In another embodiment of the present invention, a breakaway coupling for use with a fishing lure and fishing hook includes a holder having a lure-connected end and an opposite end with a first mechanical connector, and includes a coupling element having a hook-connected end and an opposite end including a second connector releasably engaging the first mechanical connector to form a breakaway mechanism. The breakaway mechanism provides a force sufficient to hold a hooked fish on the fishing line, but so that the coupling element will release from the holder before the fishing line breaks if the fishing hook becomes snagged, with one of the first and second mechanical connectors including at least one hook.

In another embodiment of the present invention, a method includes providing a holder including a loop at one end and a socket at an opposite end, said socket including an axially extending aperture terminating in a transversely extending slot through said holder; and also includes providing a coupling element including at least one resilient tine for releasably coupling said element to said socket, wherein said coupling element is adapted to receive a hook such that said coupling element releases from said holder to allow the recovery of a lure in the event of a snag. The method still further includes releasably attaching a fish hook to the holder using the coupling element.

It is contemplated that conventional hooks can be used with the present innovation, and the spool, or coupling element and holder, can be integrally molded of a polymeric material, such as PVC, ABS, or polycarbonate. The breakaway coupling member of the present invention can be used with any type of lure, spoon, spinner, or other commonly employed fish attracting lure. With such a system, different breakaway forces for different test lines employed by a fisherman can be designed by changing the test strength of the line in the first embodiment or by changing the tine geometry in the second and third embodiments. The breakaway coupling member can be color coded to alert the fisherman to the test line for which it is intended to be used.

These and other features, objects and advantages of the present invention will become apparent upon reading the following description thereof together with reference to the accompanying drawings.

### BRIEF DESCRIPTION OF THE DRAWINGS

FIG. 1 is a perspective view of a fishing lure and hook breakaway coupling member of a first embodiment of the present invention;

FIG. 2 is a perspective view of an alternative embodiment of the breakaway coupling;

FIG. 3 is a front elevational view of the breakaway coupling shown in FIG. 2;

FIG. 4 is a left-side elevational view of the breakaway coupling shown in FIG. 3;

FIG. 5 is a top plan view of the breakaway coupling shown in FIG. 4;

FIG. 6 is an exploded perspective view of the breakaway coupling and hook of FIG. 5 illustrating the coupling of the hook to the breakaway coupling; and

FIG. 7 is a fragmentary cross-sectional view of the breakaway coupling taken along section line VII-VII of FIG. 3.

### DETAILED DESCRIPTION OF THE PREFERRED EMBODIMENT

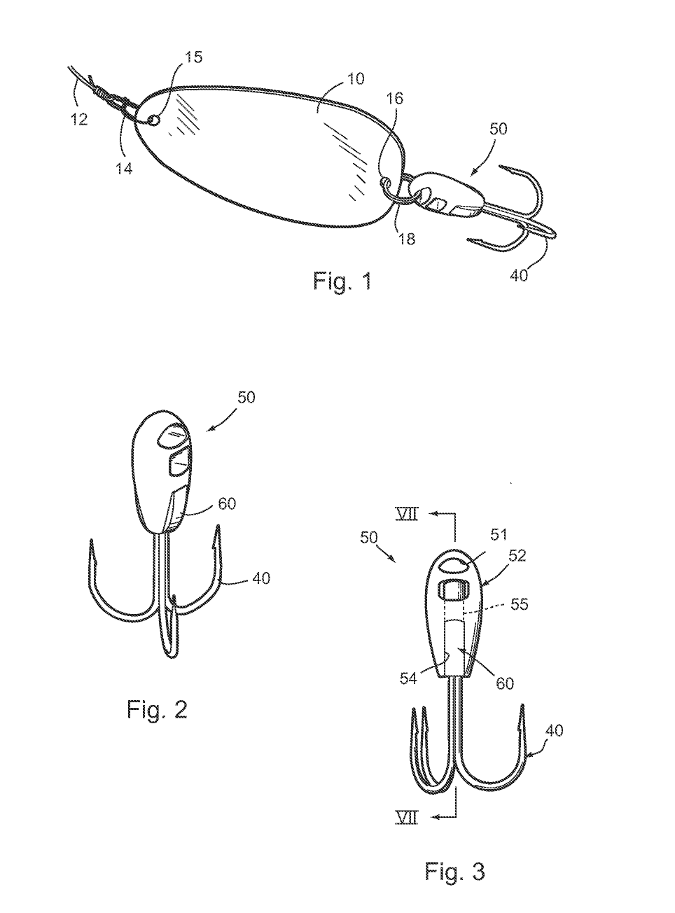

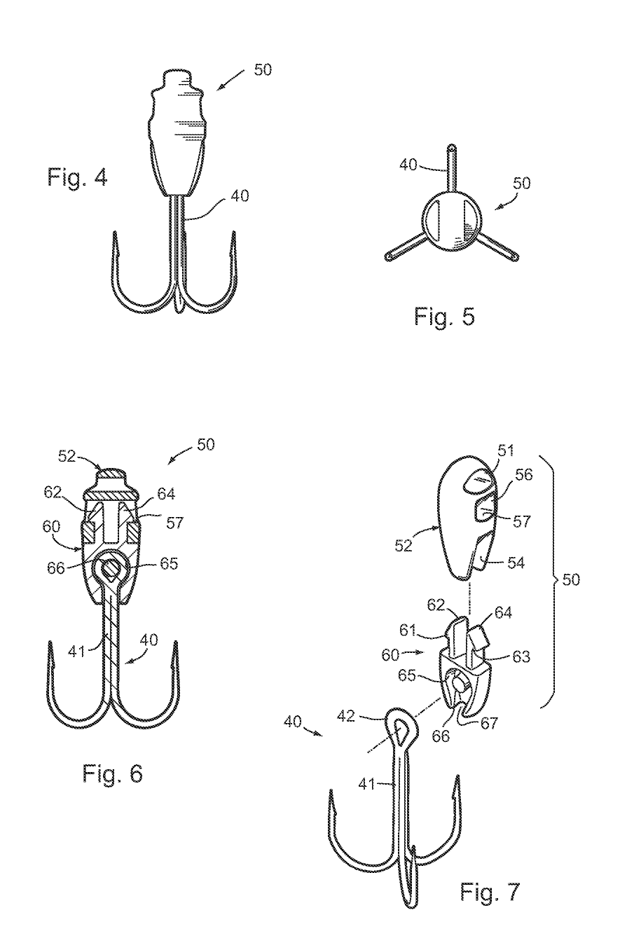

A breakaway coupling 50 (FIG. 1) is provided for securing a fishing hook 40 to a fishing lure 10 and fishing line 12, where the breakaway coupling 50 is configured to breakaway if the hook 40 becomes snagged. It is contemplated that the illustrated fishing lure 10 can be any type of lure, such as artificial bait fish, spoon, spinner, or the like. Lure 10 is coupled to a fishing line 12 leading to the surface of the water by a conventional coupling 14, which can be a snap-hook or simply a knot tied in the fishing line 12 and extending through aperture 15 in the lure 10. The opposite end of the lure includes an aperture 16 which receives a connecting ring 18 coupling the breakaway coupling 50 of the present invention to lure 10. Breakaway coupling 50 releasably couples the illustrated standard three-pronged fish hook 40 to lure 10.

The illustrated breakaway coupling 50 is integrally molded of a suitable polymeric material, such as PVC, ABS, polycarbonate, or the like. Breakaway coupling 50 comprises a holder 52 and a coupling element 60, which snap-fits within a socket 54 of holder 52. The holder 52 includes an eyelet 51 for attaching to ring 18 of a fishing lure, such as lure 10 shown in FIG. 1. The socket 54 of holder 52 includes a central axially extending aperture 55 for receiving the tines 62 and 64 of the coupling element 60. Aperture 55 extends axially upwardly through the body of holder 52 and communicates with a transversely extending slot 56 to allow the tines to compress and subsequently extend outwardly and with barbs 61 and 63 engaging the shoulders 57 on the holder 52, as best illustrated in FIG. 14.

The coupling element 60 includes a configured slot 65 with a central post 66. Slot 65 is circular and has an axially extending opening 67, allowing the shank 41 of hook 40 to extend into slot 65 with eyelet 42 extending over post 66. The hook 40 is assembled to the coupling member 50 by placing the eyelet of hook 40 over post 66 and into recess defined by the slot 65. The combination is then extended into the aperture 55 until flexible polymeric tines 62, 64 are compressed and subsequently snap outwardly into the transverse slot 56, allowing the barbs 61 and 63 to engage the shoulder 57 of the holder 52, as illustrated in FIG. 6. The holder 52 and the coupling element 50 are molded of a suitable resilient polymeric material, such as PVC, ABS, or the like. The dimensions of tines 61 and 63 are selected, such that the coupling element 60 and hook 40 will release from the holder 52 at a predetermined breakaway force selected lower than the breakaway force of the fishing line 12, such that the lure 10 and holder 52 remain with the lure and only the coupling element 60 need be replaced. The holder 52 and/or coupling element 60 can be color coded or otherwise identified (e.g. by indicia or size or shape) for different breakaway strengths to alert the fisherman as to what breakaway force is being employed with the breakaway coupling 50.

In some embodiments, it may be desirable to mold or fixedly attach the coupling element 60 directly to the eyelet 42 of hook 40 (such as by insert molding techniques or by other permanent attachment) instead of providing a first assembly step coupling the fishing hook 40 to the coupling element 60. This may add some slight cost of the assembly to the fisherman, however, it also will facilitate the fisherman's assembly of the fishing hook to the holder 52. It is also contemplated that the breakaway force can be formed by structures other that the illustrated barbs 61/63 and should 57. For example, the breakaway force could be achieved by other mechanical attachment structure (e.g. by a bulb or enlargement captured in a matingly shaped cavity) and/or by chemical or adhesive or magnetic or other direct-attachment design.

The breakaway coupling 50 (also called “coupling assembly”) can be designed for various test lines which typically in fresh water fishing can vary from as little as about two-pound test up to about twenty-pound test, with about eight to about twelve pound being the typical range. By changing the thickness or material of the snap-locking tines 62, 64 in the second embodiment, any desired breakaway force (that force in which the coupling element separates from the lure) can be achieved with the breakaway force typically being in the neighborhood of about 30% less than the test strength of the line being used. This assures that the hooks 40 will release from the lure 10 well prior to the fishing line 12 breaking, thereby allowing the fisherman to retrieve a snagged lure.

It will become apparent to those skilled in the art that various modifications to the preferred embodiment of the invention as described herein can be made without departing from the spirit or scope of the invention as defined by the appended claims.

The invention claimed is:

1. A breakaway coupling for use with a fishing lure comprising:
a holder including a loop at one end and a socket at an opposite end, the socket including an axially extending aperture terminating in a transversely extending slot through said holder; and
a coupling element including at least one resilient tine for releasably coupling the coupling element to said socket, wherein said coupling element is adapted to receive a fish hook such that said coupling element releases from the holder to allow the recovery of a lure in the event of a snag.

2. The coupling as defined in claim 1 wherein said coupling element includes a recess and post shaped to hold an eyelet of the fishing hook.

3. The coupling as defined in claim 2 wherein said coupling element snap-fits within said socket.

4. The coupling as defined in claim 3 wherein said socket is further defined by a pair of legs captively surrounding the eyelet of a fishing hook once attached to said holder.

5. The coupling as defined in claim 4 wherein said holder and coupling element are each made of a polymeric material.

6. The coupling as defined in claim 5 wherein said polymeric material is one of PVC and ABS.

7. The coupling as defined in claim 6 wherein said coupling element is color coded to indicate the release force from said holder.

8. The coupling as defined in claim 1 wherein said coupling element includes an integrally formed hook.

9. The coupling as defined in claim 1 wherein said coupling element snap-fits within said socket.

10. The coupling as defined in claim 1 wherein said socket is further defined by a pair of legs captively surrounding the eyelet of a fishing hook once attached to said holder.

11. The coupling as defined in claim 1 wherein said holder and coupling element are each made of a polymeric material.

12. The coupling as defined in claim 1 wherein said polymeric material is one of PVC and ABS.

13. A method comprising steps of:
providing a holder including a loop at one end and a socket at an opposite end, said socket including an axially extending aperture terminating in a transversely extending slot through said holder
providing a coupling element including at least one resilient tine for releasably coupling said element to said socket, wherein said coupling element is adapted to receive a hook such that said coupling element releases from said holder to allow the recovery of a lure in the event of a snag
releasably attaching a fish hook to the holder using the coupling element.

14. A breakaway coupling for use with a fishing lure and fishing hook, comprising:
a holder including a lure-connected end and an opposite end with a first mechanical connector; and
a coupling element including a hook-connected end and an opposite end including a second connector releasably engaging the first mechanical connector to form a breakaway mechanism with a force sufficient to hold a hooked fish on the fishing line, but so that the coupling element will release from the holder before the fishing line breaks if the fishing hook becomes snagged, one of the first and second mechanical connectors including at least one hook.
wherein said coupling element is adapted to receive a fish hook such that said coupling element releases from the holder to allow the recovery of a lure in the event of a snag.
